(19) United States
(12) Patent Application Publication
(10) Pub. No.: US 2016/0183153 A1
(43) Pub. Date: Jun. 23, 2016

(54) APPARATUS AND METHOD FOR SWITCHING NETWORKS

(71) Applicant: MediaTek Inc., Hsin-Chu (TW)

(72) Inventors: Yuan-Jung Kuo, New Taipei City (TW); Chi-Chen Lee, Taipei City (TW)

(21) Appl. No.: 14/907,059

(22) PCT Filed: May 15, 2015
(86) PCT No.: PCT/CN2015/079079

§ 371 Date: Jan. 22, 2016

Related U.S. Application Data
(60) Provisional application No. 61/993,570, filed on May 15, 2014.

(51) Int. Cl. H04W 36/30; H04W 36/14; H04W 36/34

(52) U.S. Cl. CPC H04W 36/30; H04W 36/34; H04W 36/14

(57) ABSTRACT

The method and apparatus for switching networks are provided. The network switching method is applied to the packet switching service of user equipment (UE). The network switching method includes the steps of determining the adoption priorities of a standard switching mechanism and a non-standard switching mechanism according to decision information.

### CROSS REFERENCE TO RELATED APPLICATIONS

This Application claims priority of U.S. Provisional Patent Application No. 61/993,570, filed on May 15, 2014, the entirety of which is incorporated by reference herein.

### BACKGROUND OF THE INVENTION

1. Field of the Invention

The invention generally relates to a service network switching technology, and more particularly, to determining the adoption priority of a standard switching mechanism and a non-standard switching mechanism.

2. Description of the Related Art

Wireless communication systems have been widely deployed to provide various telecommunication services such as telephony, video, data, messaging, and broadcast. Typical wireless communication systems may employ multiple-access technologies capable of supporting communication with multiple users by sharing available system resources (e.g., bandwidth, transmission power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Teletransmissions System (UMTS) mobile standard promulgated by the Third Generation Partnership Project (3GPP). It is designed to better support mobile broadband Internet access by improving spectral efficiency, lowering costs, improving services, making use of new spectrums, and integrating better with other open standards using OFDMA on downlinks (DL), and SC-FDMA on uplinks (UL) and multiple-input multiple-output (MIMO) antenna technology.

Because the 4G LTE standard no longer supports circuit-switched voice transmission technology, it can only be an all-IP packet-switched network under which operators need to adopt some interim solution to solve the initial LTE network construction voice transmission problems. At this stage, major chip manufacturers and the 3GPP organization have proposed different solutions for operators to choose from, including single-card dual standby technology such as SGLTE (Simultaneous GSM and LTE), SVLTE (Simultaneous Voice and LTE) or SRLTE (Single Radio LTE), dual card dual standby technology, circuit switched fallback (CSFB) technology, and so on.

Because these single-card dual standby technologies are not standardized, there would be non-standard switching mechanism between different radio access networks. Therefore, for the packet-switched (PS) service of the single-card dual standby technologies (e.g. SGLTE, SVLTE and SRLTE), when the user equipment can support a standard switching mechanism and a non-standard switching mechanism at the same time, how to adopt the standard switching mechanism and the non-standard switching mechanism is a subject worthy of discussion.

### BRIEF SUMMARY OF THE INVENTION

Apparatus and methods for switching networks are provided to overcome the problems mentioned above.

An embodiment of the invention provides a network switching method. The network switching method is applied to the packet switching service of user equipment (UE). The network switching method includes the steps of determining adoption priorities of a standard switching mechanism and a non-standard switching mechanism according to decision information.

In the embodiment of the invention, if data rate of a first target access network corresponding to the standard switching mechanism is higher than data rate of a second target access network corresponding to the non-standard switching mechanism according to the decision information, the standard switching mechanism has a higher adoption priority than the non-standard switching mechanism.

In the embodiment of the invention, if according to the decision information, data rate of a first target access network corresponding to the non-standard switching mechanism is higher than data rate of a second target access network corresponding to the standard switching mechanism, the standard switching mechanism has the same adoption priority as the non-standard switching mechanism.

Another embodiment of the invention provides a network switching method. The network switching method is applied to an autonomous reselection operation of user equipment (UE). The network switching method includes the steps of determining whether to switch from the current network to a target network according to signal strength/quality of the current network and signal strength/quality of the target network if target network has lower or equal priority or according to signal strength/quality of the target network if target network has higher priority.

An embodiment of the invention provides an apparatus for switching networks. The apparatus comprises a processor. The processor is configured to determine an adoption priority for a standard switching mechanism and a non-standard switching mechanism according to the decision information.

In the embodiment of the invention, if data rate of a first target access network corresponding to the standard switching mechanism is higher than data rate of a second target access network corresponding to the non-standard switching mechanism according to the decision information, the standard switching mechanism has a higher adoption priority than the non-standard switching mechanism.

In the embodiment of the invention, if according to the decision information, data rate of a first target access network corresponding to the non-standard switching mechanism is higher than data rate of a second target access network corresponding to the standard switching mechanism, the standard switching mechanism has the same adoption priority as the non-standard switching mechanism.

Another embodiment of the invention provides an apparatus for switching networks. The apparatus comprises a timer and a processor. The processor is configured to determine whether to switch from the current network to a target network according to signal strength/quality of the current network and signal strength/quality of the target network if target network has lower or equal priority or according to signal strength/quality of the target network if target network has higher priority.

Other aspects and features of the invention will become apparent to those with ordinary skill in the art upon review of the following descriptions of specific embodiments of methods and systems.

### BRIEF DESCRIPTION OF THE DRAWINGS

The invention will become more fully understood by referring to the following detailed description with reference to the accompanying drawings, wherein:

FIG. 1 is a block diagram of a mobile communications system 100 according to an embodiment of the invention;

FIG. 2A is a schematic diagram illustrating the standard switching mechanism and a non-standard switching mechanism according to an embodiment of the invention;

FIG. 2B is a schematic diagram illustrating the standard switching mechanism and a non-standard switching mechanism according to another embodiment of the invention;

FIG. 2C is a schematic diagram illustrating the standard switching mechanism and a non-standard switching mechanism according to another embodiment of the invention;

FIG. 2D is a schematic diagram illustrating the standard switching mechanism and a non-standard switching mechanism according to another embodiment of the invention;

FIGS. 3A-3B is a flow chart illustrating the network switching method according to an embodiment of the invention;

FIGS. 4A-4B is a flow chart illustrating the autonomous reselection operation according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

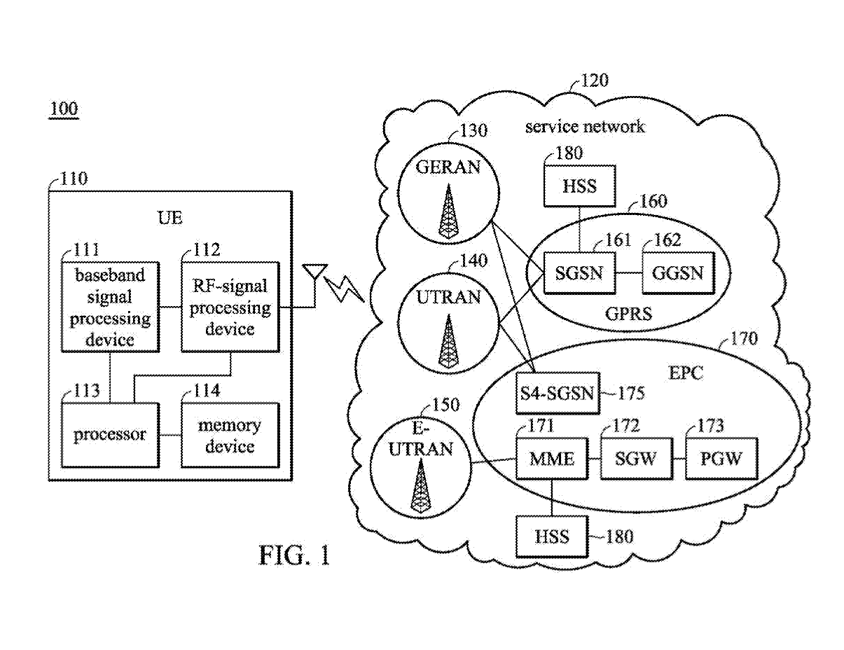

FIG. 1 is a block diagram of a mobile communications system 100 according to an embodiment of the invention. The system 100 comprises User Equipment (UE) 110 and a service network 120. The UE 110 may be a mobile communications device, such as a cellular phone, a smartphone modem processor, a data card, a laptop stick, a mobile hotspot, a USB modem, a tablet, etc..

The UE 110 may comprise at least a baseband signal processing device 111, a radio frequency (RF) signal processing device 112, a processor 113, a memory device 114, and an antenna module comprising at least one antenna. Note that, in order to clarify the concept of the invention, FIG. 1 presents a simplified block diagram in which only the elements relevant to the invention are shown. However, the invention should not be limited to what is shown in FIG. 1.

The RF signal processing device 112 may receive RF signals via the antenna and process the received RF signals to convert the received RF signals to baseband signals to be processed by the baseband signal processing device 111, or receive baseband signals from the baseband signal processing device 111 and convert the received baseband signals to RF signals to be transmitted to a peer communications apparatus. The RF signal processing device 112 may comprise a plurality of hardware elements to perform radio frequency conversion. For example, the RF signal processing device 112 may comprise a power amplifier, a mixer, etc..

The baseband signal processing device 111 may further process the baseband signals to obtain information or data transmitted by the peer communications apparatus. The baseband signal processing device 111 may also comprise a plurality of hardware elements to perform baseband signal processing. The baseband signal processing may comprise analog-to-digital conversion (ADC)/digital-to-analog conversion (DAC), gain adjustment, modulation/demodulation, encoding/decoding, and so on.

The processor 113 may control the operations of the baseband signal processing device 111 and the RF signal processing device 112. According to an embodiment of the invention, the processor 113 may also be arranged to execute the program codes of the software module(s) of the corresponding baseband signal processing device 111 and/or the RF signal processing device 112. The program codes accompanied by specific data in a data structure may also be referred to as a processor logic unit or a stack instance when being executed. Therefore, the processor 113 may be regarded as being comprised of a plurality of processor logic units, each for executing one or more specific functions or tasks of the corresponding software module(s).

The memory device 114 may store the software and firmware program codes, system data, user data, etc. of the UE 110. The memory device 114 may be a volatile memory such as a Random Access Memory (RAM); a non-volatile memory such as a flash memory or Read-Only Memory (ROM); a hard disk; or any combination thereof.

According to an embodiment of the invention, the RF signal processing device 112 and the baseband signal processing device 111 may collectively be regarded as a radio module capable of communicating with a wireless network to provide wireless communications services in compliance with a predetermined Radio Access Technology (RAT). Note that, in some embodiments of the invention, the UE 110 may be extended further to comprise more than one antenna and/or more than one radio module, and the invention should not be limited to what is shown in FIG. 1.

In addition, in some embodiments of the invention, the processor 113 may be configured inside of the baseband signal processing device 111, or the UE 110 may comprise another processor configured inside of the baseband signal processing device 111. Thus the invention should not be limited to the architecture as shown in FIG. 1.

The service network 120 may comprise a GSM EDGE Radio Access Network (GERAN) 130, a Universal Terrestrial Radio Access Network (UTRAN) 140, an Evolved UTRAN (E-UTRAN) 150, a General Packet Radio Service (GPRS) subsystem 160 and an Evolved Packet Core (EPC) subsystem 170. The GERAN 130, UTRAN 140 and E-UTRAN 150 may be in communication with the GPRS subsystem 160 or the EPC subsystem 170, wherein the GERAN 130, UTRAN 140 and E-UTRAN 150 allow connectivity between the UE 110 and the GPRS subsystem 160 or the EPC subsystem 170 by providing the functionality of wireless transmission and reception to and from the UE 110 for the GPRS subsystem 160 or the EPC subsystem 170, and the GPRS subsystem 160 or the EPC subsystem 170 signals the required operation to the GERAN 130, UTRAN 140 and E-UTRAN 150 for providing wireless services to the UE 110. The GERAN 130, UTRAN 140 and E-UTRAN 150 may contain one or more base stations (or called NodeBs or eNodeBs) and Radio Network Controllers (RNCs). Specifically, the GPRS subsystem 160 includes a Serving GPRS (General Packet Radio Services) Support Node (SGSN) 161 and a Gateway GPRS Support Node (GGSN) 162, wherein the SGSN 161 is the key control node for packet routing and transfer, mobility management (e.g., attach/detach and location management), session management, logical link management, and authentication and charging functions, etc., and the GGSN 162 is responsible for Packet Data Protocol (PDP) address assignments and inter-working with external networks. The EPC subsystem 170 may comprise a Mobility Management Entity (MME) 171, which may be responsible for idle mode UE tracking, paging procedures, and attachment and activation processes. The EPC subsystem 170 may also comprise a Servicing Gateway (SGW) 172, which may be responsible for the routing and forwarding of data packets. The EPC subsystem 170 may also include a Packet data network Gateway (PGW) 173, which may be responsible for providing connectivity from the UE 110 to external networks. Both the SGSN 161 and the MME 171 may be in communication with Home Subscriber Server (HSS) 180 which may provide device identification information, an International Mobile Subscriber Identity (IMSI), etc. It should be appreciated that the EPC subsystem 170 may also comprise a S4-SGSN 175, thereby allowing the GERAN 130 or UTRAN 140 to be accessed when the GPRS subsystem 160 is replaced by the EPC subsystem 170. Additionally, the service network 120 may further include other functional entities, such as a Home Location Register (HLR) (not shown) which is a central database storing user-related and subscription-related information, and the invention is not limited thereto. In an embodiment of the invention, the service network 120 may further comprise a Code Division Multiple Access (CDMA) network.

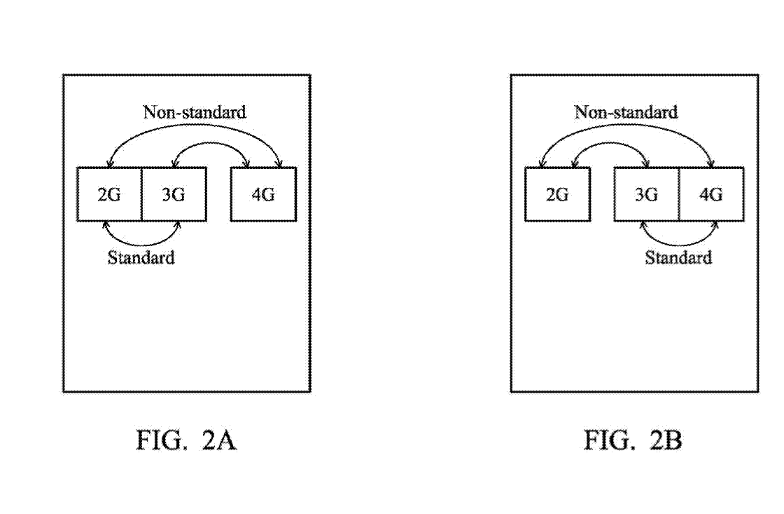

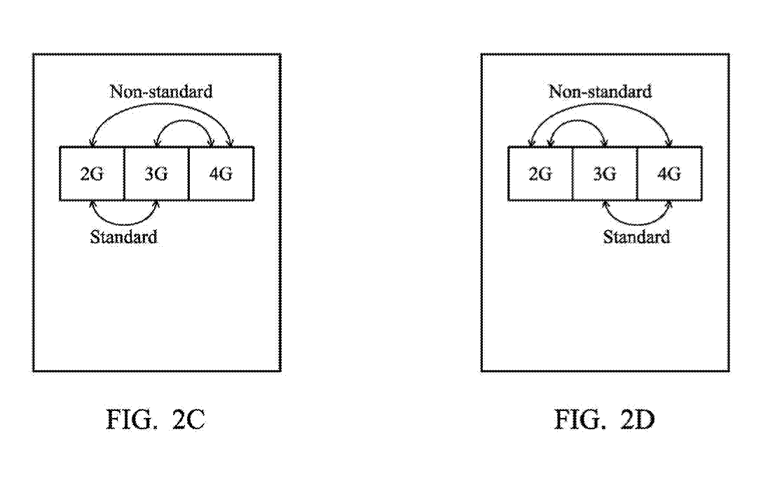

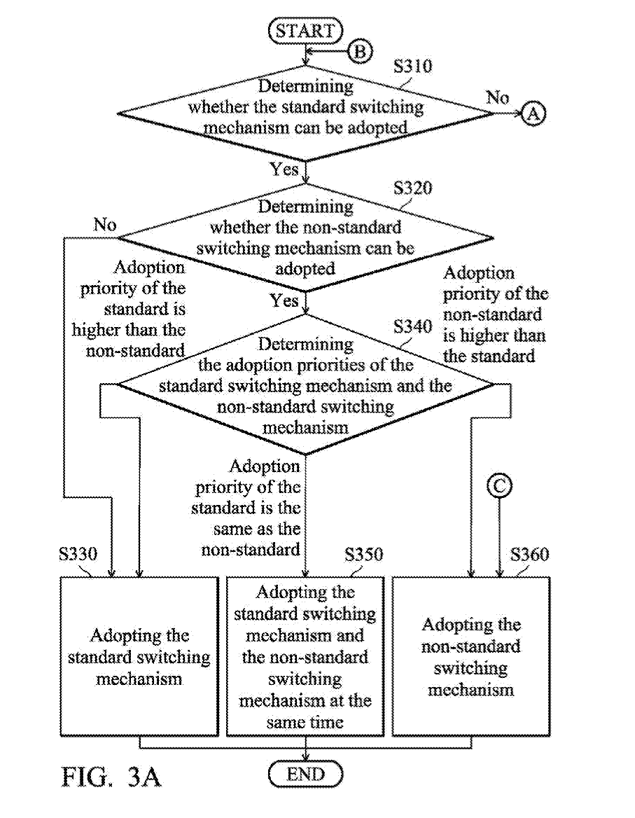

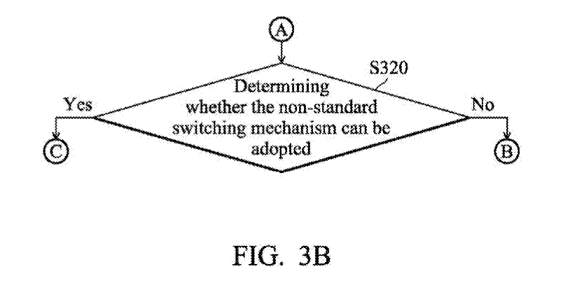

In an embodiment of the invention, for the packet-switched (PS) service, the UE 110 supports a standard (e.g. Single Active) switching mechanism and a non-standard (e.g. Dual Active) switching mechanism. FIG. 2A is a schematic diagram illustrating the standard switching mechanism and a non-standard switching mechanism according to an embodiment of the invention. As shown in FIG. 2A, if the 2G network module and 3G network module are combined in one chip or in same logical function group (or the 2G module and 3G module share the same RF module), and the 4G network module is allocated in another chip or in another logical function group (or the 4G network module uses another RF module), the standard switching mechanism means the operations of switching the networks between 2G network and 3G network (switch from 2G network to 3G network or switch from 3G network to 2G network), and the non-standard switching mechanism means the operations of switching the networks between 2G network and 4G network or 3G network and 4G network. FIG. 2B is a schematic diagram illustrating the standard switching mechanism and a non-standard switching mechanism according to another embodiment of the invention. As shown in FIG. 2B, if the 3G network module and 4G network module are combined in one chip or in same logical function group (or the 3G module and 4G module share the same RF module), and the 2G network module is allocated in another chip or in another logical function group (or the 2G network module uses another RF module), the standard switching mechanism means the operations of switching the networks between 3G network and 4G network (switch from 3G network to 4G network or switch from 4G network to 3G network), and the non-standard switching mechanism means the operations of switching the networks between 2G network and 3G network or 2G network and 4G network. FIG. 2C is a schematic diagram illustrating the standard switching mechanism and a non-standard switching mechanism according to another embodiment of the invention. As shown in FIG. 2C, if the 2G network module, 3G network module and 4G network module are combined in one chip or in same logical function group (or the 2G network module, 3G network module and 4G network module share the same RF module), the standard switching mechanism means the operations of switching the networks between 2G network and 3G network (switch from 2G network to 3G network or switch from 3G network to 2G network), and the non-standard switching mechanism means the operations of switching the networks between 2G network and 4G network or 3G network and 4G network. FIG. 2D is a schematic diagram illustrating the standard switching mechanism and a non-standard switching mechanism according to another embodiment of the invention. As shown in FIG. 2D, if the 2G network module, 3G network module and 4G network module are combined in one chip or in same logical function group (or the 2G network module, 3G network module and 4G network module share the same RF module), the standard switching mechanism means the operations of switching the networks between 3G network and 4G network (switch from 3G network to 4G network or switch from 4G network to 3G network), and the non-standard switching mechanism means the operations of switching the networks between 2G network and 3G network or 2G network and 4G network. In an embodiment of the invention, the standard switching mechanism and the non-standard switching mechanism can be applied to SGLTE (Simultaneous GSM and LTE), SVLTE (Simultaneous Voice and LTE) or SRLTE (Single Radio LTE).

In an embodiment of the invention, when the UE 110 will be out of service from a current network which it is currently camping on, the UE 110 will determine an adoption priority for a standard switching mechanism and a non-standard switching mechanism according to the decision information. In an embodiment of the invention, the UE 110 may perform an out-of-service (OOS) recovery search operation to find a network to camp on, if the UE 110 has been out of service from the current network. In an embodiment of the invention, the standard switching mechanism always has the highest adoption priority according to the decision information.

In an embodiment of the invention, if the standard switching mechanism is adopted, the UE 110 or service network 120 may determine whether to perform the standard switching mechanism (cell reselection or redirection) according to 3GPP or 3GPP2 standard. In another embodiment of the invention, if the non-standard switching mechanism is adopted the UE 110 may determine whether to perform the non-standard switching mechanism according one or more threshold (e.g. signal strength/quality of the current network and target network, measured result of the UE 110, etc.), wherein the threshold is defined by the UE 110 or is provided by a service network 120.

In an embodiment of the invention, the decision information may comprise the data rates of the target access networks corresponding to the standard switching mechanism and the non-standard switching mechanism.

In an embodiment of the invention, if the data rate of the target access network (e.g. 4G or 3G) corresponding to the standard switching mechanism is higher than the data rate of the target access network (e.g. 2G) corresponding to the non-standard switching mechanism, the standard switching mechanism may have a higher adoption priority than the non-standard switching mechanism. Namely, in this embodiment, the operations of switching the networks between 3G network and 4G network means the standard switching mechanism, and the operations of switching the networks between 2G network and 3G network or 2G network and 4G network means the non-standard switching mechanism. In this embodiment, if the standard switching mechanism is adopted by the UE 110, the UE 110 will not concern the non-standard switching mechanism temporarily. Only when the UE 110 can't adopt the standard switching mechanism will the UE 110 adopt the non-standard switching mechanism.

For example, in an embodiment of the invention, if the UE 110 is camping on a 3G network or 4G network (current network) and in an idle mode, the UE 110 may determine whether a service network 120 allocates at least one first neighbor cell/frequency of a first target network (i.e. allocate 3G neighbor cell/frequency in 4G network or allocate 4G neighbor cell/frequency in 3G network) corresponding to the standard switching mechanism according to the decision information to determine whether the standard switching mechanism can be adopted. Namely, the UE 100 may determine whether to perform cell reselection. In addition, UE 110 may also determine whether a second neighbor cell/frequency of a second target network (i.e. 2G network) corresponding to the non-standard switching mechanism exists (can be detected by UE) according to the decision information to determine whether the non-standard switching mechanism can be adopted.

If the service network 120 has allocated the first neighbor cell/frequency of the first target network, the UE 110 will adopt the standard switching mechanism. In an embodiment of the invention, if the switch conditions are fulfilled (e.g. serving cell signal strength/quality is lower than a threshold and target cell signal strength/quality is higher than a threshold or target cell signal strength/quality is higher than a threshold), the UE 110 will perform the standard switching mechanism and switch the current network to the first target network.

If the service network 120 has not allocated the first neighbor cell/frequency of the first target network and the second neighbor cell/frequency of the second target network exists, the UE 110 will adopt the non-standard switching mechanism, and then determine whether to switch from the current network to the second target network corresponding to the non-standard switching mechanism according to an autonomous reselection operation. Until the UE 110 finds the 3G network or 4G network again, or the signals of the 3G network or 4G network changes to better quality, the UE 110 may determine to switch to the 3G network or 4G network.

If the service network 120 has not allocated the first neighbor cell/frequency of the first target network and the second neighbor cell/frequency of the second target network does not exist (i.e. the standard switching mechanism and the non-standard switching mechanism can't be adopted), the UE 110 will redetermine whether to adopt the standard switching mechanism according to the decision information.

In another example, in another embodiment of the invention, if the UE 110 is camping on a 3G network or 4G network (current network) and in a connection mode, the UE 110 may determine whether a service network 120 requests to measure the signal strength/quality of a first neighbor cell/frequency of a first target network (i.e. requests to measure the signal strength/quality of a 3G neighbor cell/frequency in 4G network or requests to measure the signal strength/quality of a 4G neighbor cell/frequency in 3G network) corresponding to the standard switching mechanism according to the decision information to determine whether the standard switching mechanism can be adopted. In addition, the UE 110 may also determine whether a second neighbor cell/frequency of a second target network corresponding to the non-standard switching mechanism exists according to the decision information to determine whether the non-standard switching mechanism can be adopted.

If the service network 120 has requested to measure the signal strength of the first neighbor cell/frequency of the first target network, the UE 110 may adopt the standard switching mechanism, and then perform a redirection operation for 3G network and 4G network.

If the service network 120 has not requested to measure the signal strength/quality of the first neighbor cell/frequency of the first target network and the second neighbor cell/frequency of the second target network exists, the UE 110 may adopt the non-standard switching mechanism, and then determine whether to switch from the current network to the second target network corresponding to the non-standard switching mechanism according to an autonomous reselection operation. Until the UE 110 finds the 3G network or 4G network again, or the signals of the 3G network or 4G network changes to better quality, the UE 110 may determine to switch to the 3G network or 4G network.

If the service network 120 has not requested to measure the signal strength/quality of the first neighbor cell/frequency of the first target network and the second neighbor cell/frequency of the second target network does not exist (i.e. the standard switching mechanism and the non-standard switching mechanism can't be adopted), the UE 110 will redetermine whether to adopt the standard switching mechanism according to the decision information.

In another embodiment of the invention, if the data rate of the target access network (e.g. 2G and 3G) corresponding to the standard switching mechanism is lower than the data rate of the target access network (e.g. 4G) corresponding to the non-standard switching mechanism, the standard switching mechanism may have the same adoption priority as the non-standard switching mechanism. Namely, in this embodiment, the operations of switching the networks between 2G network and 3G network means the standard switching mechanism, and the operations of switching the networks between 2G network and 4G network or 3G network and 4G network means the non-standard switching mechanism. In this embodiment, if the standard switching mechanism is adopted by the UE 110, the UE 110 may also determine whether can adopt the non-standard switching mechanism at the same time, because the standard switching mechanism may have the same adoption priority as the non-standard switching mechanism.

For example, in an embodiment of the invention, if the UE 110 is camping on a 2G network or 3G network (current network) and in an idle mode, the UE 110 may determine whether a service network 120 allocates at least one first neighbor cell/frequency of a first target network (i.e. allocate 2G neighbor cell/frequency in 3G network or allocate 3G neighbor cell/frequency in 2G network) corresponding to the standard switching mechanism according to the decision information to determine whether the standard switching mechanism can be adopted. Namely, the UE 100 may determine whether to perform cell reselection. In addition, the UE 110 may also determine whether a second neighbor cell/frequency of a second target network (i.e. 4G network) corresponding to the non-standard switching mechanism exists according to the decision information to determine whether the standard switching mechanism can be adopted.

If the service network 120 has allocated the first neighbor cell/frequency of the target network and the second neighbor cell/frequency of the second target network exists, the UE 110 may adopt the standard switching mechanism and the non-standard switching mechanism at the same time and then switch from the current network to the first target network or to the second target network according to which switching mechanism makes a decision result first. In an embodiment of the invention, if the standard switching mechanism makes the decision result first, the UE 110 will switch from the current network to the first target network. In another embodiment of the invention, if the non-standard switching mechanism makes the decision result first, which is according to an autonomous reselection operation, the UE 110 will switch from the current network to the second target network.

If the service network 120 has allocated the first neighbor cell/frequency of the first target network but the second neighbor cell/frequency of the second target network does not exist, the UE 110 will adopt the standard switching mechanism.

If the service network 120 has not allocated the first neighbor cell/frequency of the first target network but the second neighbor cell/frequency of the second target network exists, the UE 110 will adopt the non-standard switching mechanism, and then determine whether to switch from the current network to the second target network corresponding to the non-standard switching mechanism according to an autonomous reselection operation.

If the service network 120 has not allocated the first neighbor cell/frequency of the first target network and the second neighbor cell/frequency of the second target network does not exist (i.e. the standard switching mechanism and the non-standard switching mechanism can't be adopted), the UE 110 will adopt redetermine whether to adopt the standard switching mechanism and the non-standard switching mechanism at the same time according to the decision information.

In another example, in another embodiment of the invention, if the UE 110 is camping on a 2G network or 3G network (current network) and in a connection mode, the UE 110 may determine whether a service network 120 requests to measure the signal strength/quality of a first neighbor cell/frequency of a first target network (i.e. requests to measure the signal strength/quality of a 2G neighbor cell/frequency in 3G network or requests to measure the signal strength/quality of a 3G neighbor cell/frequency in 2G network) corresponding to the standard switching mechanism according to the decision information to determine whether the standard switching mechanism can be adopted. In addition, the UE 110 may also determine whether a second neighbor cell/frequency of a second target network (4G network) corresponding to the non-standard switching mechanism exists according to the decision information to determine whether the non-standard switching mechanism can be adopted.

If the service network 120 has requested to measure the signal strength/quality of the first neighbor cell/frequency of the first target network corresponding to the standard switching mechanism and the second neighbor cell/frequency of the second target network exists, the UE 110 will adopt the standard switching mechanism and the non-standard switching mechanism at the same time, and then switch from the current network to the first target network or to the second target network according to which switching mechanism makes a decision result first. In an embodiment of the invention, if the standard switching mechanism makes the decision result first, the UE 110 will switch from the current network to the first target network. In another embodiment of the invention, if the non-standard switching mechanism makes the decision result first, which is according to an autonomous reselection operation, the UE 110 will switch from the current network to the second target network.

If the service network 120 has requested to measure the signal strength/quality of the first neighbor cell/frequency of the first target network corresponding to the standard switching mechanism, but the second neighbor cell/frequency of the second target network does not exist, the UE 110 may adopt the standard switching mechanism, and then service network 120 performs a switch operation, (e.g. redirection) for 2G network and 3G network.

If the service network 120 has not requested to measure the signal strength/quality of the first neighbor cell/frequency of the first target network corresponding to the standard switching mechanism, but the second neighbor cell/frequency of the second target network exists, the UE 110 will adopt the non-standard switching mechanism, and then determine whether to switch from the current network to the second target network corresponding to the non-standard switching mechanism according to an autonomous reselection operation.

If the service network 120 has not requested to measure the signal strength/quality of the first neighbor cell/frequency of the first target network corresponding to the standard switching mechanism, and the second neighbor cell/frequency of the second target network does not exist (i.e. the standard switching mechanism and the non-standard switching mechanism can't be adopted), the UE 110 will redetermine whether to adopt the standard switching mechanism and the non-standard switching mechanism at the same time according to the decision information.

In another embodiment of the invention, if the data rate of the target access network (e.g. 2G and 3G) corresponding to the standard switching mechanism is lower than the data rate of the target access network (e.g. 4G) corresponding to the non-standard switching mechanism, the non-standard switching mechanism may have a higher adopting priority than the standard switching mechanism. Because, the operations for this embodiment are the same as the above embodiments, not repeat them.

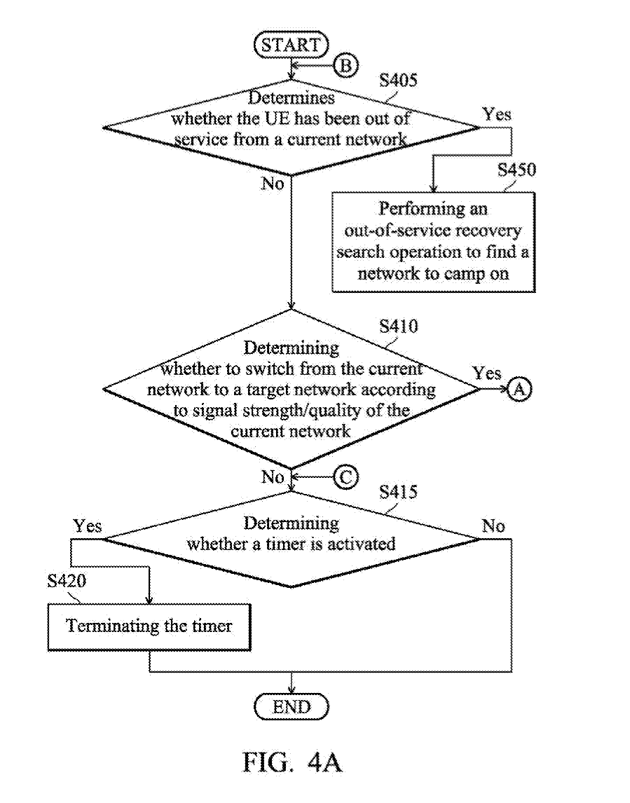

FIGS. 3A-3B is a flow chart illustrating the network switching method according to an embodiment of the invention. The network switching method is applied to the communications system 100. First, in step S310, the UE 110 will determine whether the standard switching mechanism can be adopted. In step S320, the UE 110 may determine whether the non-standard switching mechanism can be adopted. If the standard switching mechanism can be adopted but the non-standard switching mechanism can't be adopted, step S330 will be performed. In step S330, the UE 110 will adopt the standard switching mechanism (e.g. cell reselection, handover, cell change order or redirection).

In an embodiment of the invention, the UE 110 determines whether the standard switching mechanism can be adopted by determining whether a service network 120 allocates at least one first neighbor cell/frequency of a target network corresponding to the standard switching mechanism or determining whether a service network 120 requests to measure the signal strength/quality of a first neighbor cell/frequency of a target network corresponding to the standard switching mechanism. Therefore, in step S330, the UE 110 adopts the standard switching mechanism.

If the standard switching mechanism can be adopted and the non-standard switching mechanism can also be adopted, step S340 will be performed. In step S340, the UE 110 will determine the adoption priorities of the standard switching mechanism and the non-standard switching mechanism. If the adoption priority of the standard switching mechanism is higher than the non-standard switching mechanism, step S330 will be performed. If the adoption priority of the standard switching mechanism is the same as the non-standard switching mechanism, step S350 will be performed. In step S350, the UE 110 will adopt the standard switching mechanism and the non-standard switching mechanism at the same time, and then switch from the current network to the first target network or to the second target network according to which switching mechanism makes a decision result first. If the adopting priority of the non-standard switching mechanism is higher than the standard switching mechanism, step S360 will be performed. In step S360, the UE 110 will adopt the non-standard switching mechanism.

If the standard switching mechanism can't be adopted but the non-standard switching mechanism can be adopted, step S360 will be performed. In an embodiment of the invention, in step S360, when the UE 110 adopts the non-standard switching mechanism, the UE 110 will determine whether to switch from the current network to the target network corresponding to the non-standard switching mechanism according to an autonomous reselection operation (i.e. UE switches to target network without control of current network).

If the standard switching mechanism can't be adopted and the non-standard switching mechanism also can't be adopted, the method returns to step S310.

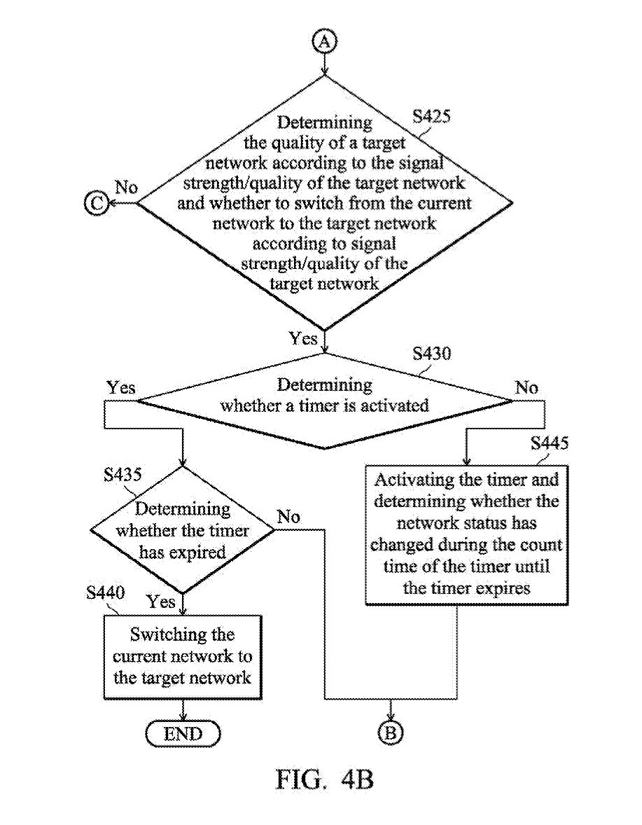

FIGS. 4A-4B is a flow chart illustrating the autonomous reselection operation according to an embodiment of the invention. The autonomous reselection operation is applied to the communications system 100. In step S405, the UE 110 determines whether the UE 100 has been out of service from a current network. If the UE 110 has not been out of service from the current network, step S410 will be performed. In step S410, the UE determines whether to switch from the current network to a target network according to signal strength/quality of the current network if target network has lower or equal priority than current network. If the UE 110 determines that the quality of the current network is not bad (higher than a threshold) according to signal strength/quality of the current network, step S415 will be performed. In step S415, the UE 110 determines whether a timer is activated. If the timer has been activated, the UE will terminate the timer (S420).

If target network has lower or equal priority than current network and the UE 110 determines that the quality of the current network is bad (lower than a threshold) and the UE 110 needs to switch from the current network to the target network according to signal strength/quality of the current network or if target network has higher priority than current network, step S425 will be performed. In step S425, the UE determines the quality of a target network according to the signal strength/quality of the target network and determines whether to switch from the current network to the target network according to signal strength/quality of the target network. If the UE 110 determines that the quality of the target network is bad (lower than a threshold) according to the signal strength/quality of the target network, step S415 will be performed. If the UE 110 determines that the quality of the target network is good enough (higher than a threshold) according to the signal strength/quality of the target network, step 5430 will be performed. In step 5430, the UE 110 determines whether a timer is activated. If the timer has been activated, the UE will determine whether the timer has expired (S435). If the timer has expired, the UE 110 will switch the current network to the target network (S440). If the timer has not expired, the UE 110 may determine continuously whether the network status has changed during the count time of the timer until the timer expires. In the embodiment, the timer is configured to provide a buffer time to the UE 110, the UE 110 can determine whether the signal strength/quality of the current network has changed to a better status (higher than a threshold) during the buffer time. If the signal strength/quality of the current network has recovered, the UE 110 may determine not to change the current network to the target network. In an embodiment, of the invention, the timer length may 4 second.

In an embodiment of the invention, switch conditions are either serving cell signal strength/quality is lower than a threshold and target cell signal strength/quality is higher than a threshold or target cell signal strength/quality is higher than a threshold.

In an embodiment of the invention, the UE 110 determines the quality of the current network and the target network according to the Reference Signal Received Power (RSRP), Reference Signal Received Quality (RSRQ), Received Signal Code Power (RSCP), Received Signal strength/quality Indicator (RSSI) and Ec/Io, wherein the RSRP and/or RSRQ is applied to the 4G network, RSCP is applied to the 3G network, RSSI is applied to the 2G network, and Ec/Io is applied to the CDMA network.

If the timer has not been activated, the UE will activate the timer and determine whether the network status has changed during the count time of the timer until the timer expires (S445). If the UE 110 has been out of service from the current network, step S450 will be performed. In step S450, the UE will perform an out-of-service (OOS) recovery search operation to find a network to camp on.

Therefore, when the UE can support a standard switching mechanism and a non-standard switching mechanism at the same time, the UE can determine to adopt and perform according to the standard switching mechanism and the non-standard switching mechanism according to the methods of the embodiments of the invention.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer software product may comprise packaging materials.

The above paragraphs describe many aspects. Obviously, the teaching of the invention can be accomplished by many methods, and any specific configurations or functions in the disclosed embodiments only present a representative condition. Those who are skilled in this technology can understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A network switching method, which is applied to a packet switching service of user equipment (UE), the network switching method comprising:
determining adoption priorities of a standard switching mechanism and a non-standard switching mechanism according to decision information.

2. The method of claim 1, wherein if data rate of a first target access network corresponding to the standard switching mechanism is higher than data rate of a second target access network corresponding to the non-standard switching mechanism according to the decision information, the standard switching mechanism has a higher adoption priority than the non-standard switching mechanism.

3. The method of claim 1, when the UE is in an idle mode, further comprising:
determining whether a service network has allocated a first neighbor cell/frequency of a first target network corresponding to the standard switching mechanism according to the decision information; and
determining whether a second neighbor cell/frequency of a second target network corresponding to the non-standard switching mechanism exists according to the decision information.

4. The method of claim 1, when the UE is in a connection mode, further comprising:
determining whether a service network requests to measure signal strength/quality of a first neighbor cell/frequency of a first target network corresponding to the standard switching mechanism according to the decision information; and
determining whether a second neighbor cell/frequency of a second target network corresponding to the non-standard switching mechanism exists according to the decision information.

5. The method of claim 1, wherein if according to the decision information, data rate of a first target access network corresponding to the non-standard switching mechanism is higher than data rate of a second target access network corresponding to the standard switching mechanism, the standard switching mechanism has the same adoption priority as the non-standard switching mechanism.

6. The method of claim 5, further comprising:
adopting the standard switching mechanism and the non-standard switching mechanism at the same time if the service network has allocated a first neighbor cell/frequency of a first target network and a second neighbor cell/frequency of a second target network exists, or if the service network has requested to measure the signal strength/quality of the first cell/frequency of the first target network corresponding to the standard switching mechanism and the second neighbor cell/frequency of the second target network exists; and
switching the current network to the first target network or the second target network according to which switching mechanism makes a decision result first, wherein if the standard switching mechanism makes the decision result first, the current network is switched to the first target network, and if the non-standard switching mechanism makes the decision result first, which is according to an autonomous reselection operation, the current network is switched to the second target network.

7. A network switching method, which is applied to an autonomous reselection operation of user equipment (UE), the network switching method comprising:
determining whether to switch from the current network to a target network according to signal strength/quality of the current network and signal strength/quality of the target network if target network has lower or equal priority or according to signal strength/quality of the target network if target network has higher priority.

8. The method of claim 7, further comprising:
determining whether a timer is activated, if switch conditions are fulfilled; and
if the timer has been activated, switching from the current network to the target network when the activated timer has expired and network status has not been changed.

9. The method of claim 8, further comprising:
activating the timer if the timer has not been activated; and
switching from the current network to the target network when the activated timer has expired and the network status has not been changed.

10. An apparatus for switching networks, comprising:
a processor, configured to determine an adoption priority for a standard switching mechanism and a non-standard switching mechanism according to decision information.

11. The apparatus of claim 10, wherein if data rate of a first target access network corresponding to the standard switching mechanism is higher than data rate of a second target access network corresponding to the non-standard switching mechanism according to the decision information, the standard switching mechanism has a higher adoption priority than the non-standard switching mechanism.

12. The apparatus of claim 10, wherein when the apparatus is in an idle mode, the processor further determines whether a service network allocates a first neighbor cell/frequency of a first target network corresponding to the standard switching mechanism according to the decision information, and determines whether a second neighbor cell/frequency of a second target network corresponding to the non-standard switching mechanism exists according to the decision information.

13. The apparatus of claim 10, wherein when the apparatus is in a connection mode, the processor further determines whether a service network requests to measure signal strength/quality of a first neighbor cell/frequency of a first target network corresponding to the standard switching mechanism according to the decision information and determines whether a second neighbor cell/frequency of a second target network corresponding to the non-standard switching mechanism exists according to the decision information.

14. The apparatus of claim 10, wherein if according to the decision information, data rate of a first target access network corresponding to the non-standard switching mechanism is higher than data rate of a second target access network corresponding to the standard switching mechanism, the standard switching mechanism has the same adoption priority as the non-standard switching mechanism.

15. The apparatus of claim 14, wherein if the service network has allocated a first neighbor cell/frequency of the first target network and a second neighbor cell/frequency of the second target network exists, or if the service network has requested to measure the signal strength/quality of the first neighbor cell/frequency of the first target network corresponding to the standard switching mechanism and the second neighbor cell/frequency of the second target network exists, the processor further adopts the standard switching mechanism and the non-standard switching mechanism at the same time and switches the current network to the first target network or the second target network according to which switching mechanism makes a decision result first, wherein if the standard switching mechanism makes the decision result first, the processor switches the current network to the first target network, and if the non-standard switching mechanism makes the decision result first, which is according to an autonomous reselection operation, the processor switch the current network to the second target network.

16. An apparatus for switching networks, comprising:
a processor, configured to determine whether to switch from the current network to a target network according to signal strength/quality of the current network and signal strength/quality of the target network if target network has lower or equal priority or according to signal strength/quality of the target network if target network has higher priority.

17. The apparatus of claim 16, wherein if switch conditions are fulfilled, the processor further determines whether a timer is activated, and if the timer has been activated, the processor switches the current network to the target network when the activated timer has expired and network status has not been changed.

18. The apparatus of claim 17, wherein if the timer has not been activated, the processor further activates the timer, and when the activated timer has expired and the network status has not been changed, the processor switches from the current network to the target network.
